(19) United States
(12) Patent Application Publication
(10) Pub. No.: US 2024/0208309 A1
(43) Pub. Date: Jun. 27, 2024

(54) LOCKING DEVICE AND CARRIAGE COVER

(71) Applicant: Shanghai Yinta NetWork Technology Co., Ltd., Shanghai (CN)

(72) Inventor: Junling Bao, Shanghai (CN)

(73) Assignee: Shanghai Yinta NetWork Technology Co., Ltd., Shanghai (CN)

(21) Appl. No.: 18/514,162

(22) Filed: Nov. 20, 2023

(30) Foreign Application Priority Data
Dec. 26, 2022 (CN) 202223478966.5

(51) Int. Cl. B60J 7/19

(52) U.S. Cl. CPC B60J 7/198

(57) ABSTRACT

A locking device includes a locking block, a handle, and a locking component. The locking block can abut against a carriage. The handle is slidably disposed in the locking block. The locking component is disposed on the handle and can be engaged in a positioning recess of the locking block. When the locking component is engaged in the positioning recess, the locking component restricts relative movement between the locking block and the handle. The carriage cover includes a carriage cover body, a first mounting strip, a second mounting strip, and the locking device. The first mounting strip and the second mounting strip are perpendicular to each other and are disposed on the lower side of the carriage cover body. The locking device is disposed on the second mounting strip.

### CROSS-REFERENCE TO RELATED APPLICATION

This application claims priority to Chinese Patent Application No. 202223478966.5 filed Dec. 26, 2022, the disclosure of which is incorporated herein by reference in its entirety.

### TECHNICAL FIELD

The present disclosure relates to the field of carriage cover technology and, in particular, to a locking device and a carriage cover.

### BACKGROUND

A pickup truck is a vehicle that uses a car head and a driver's cab and having an open truck carriage. Generally, during the use of the pickup truck, goods are often placed on the carriage, and thus being easily damaged by the sun and rain. Thus, a carriage cover for covering the carriage is hingedly disposed on the carriage to protect the goods and several locking mechanisms are disposed on the carriage cover, so that the carriage cover is stably connected on the carriage.

However, in the related art, it is not stable to fix a carriage cover on a carriage only by a handle in a locking mechanism. Specifically, during the driving process of a vehicle, especially when the vehicle bumps in some poor road conditions, the handle is easy to be detached from the carriage, which makes the carriage cover loses acting force and cannot continue covering the carriage, resulting in significant safety accidents.

### SUMMARY

The present disclosure provides a locking device and a carriage cover, so that the locking device is not easy to be detached during the running process of a vehicle, thereby ensuring that the carriage cover stably covers the carriage.

A locking device is configured to be engaged with the carriage. The locking device includes a locking block, a handle, and a locking component.

The locking block can abut against the carriage.

The handle is slidably disposed in the locking block.

The locking component is disposed on the handle and can be engaged in a positioning recess of the locking block. When the locking component is engaged in the positioning recess, the locking component restricts relative movement between the locking block and the handle.

In some embodiments, the locking component includes a positioning member and a guide frame. The guide frame is disposed on the handle. The positioning member is slidably disposed in the guide frame and can be engaged in the positioning recess.

In some embodiments, the positioning member includes a long strip plate. The long strip plate can be engaged in the positioning recess. The guide frame is formed with a bypass groove. The long strip plate is located in the bypass groove and can slide in the bypass groove.

In some embodiments, the positioning member also includes an operation boss disposed on the long strip plate. The guide frame is also formed with a sliding channel extending in a first direction. The operation boss is restricted in the sliding channel. When the operation boss moves in the sliding channel in the first direction, the long strip plate synchronously moves in the bypass groove in the first direction.

In some embodiments, the locking component also includes an elastic member disposed in the guide frame. Two ends of the elastic member abut against the guide frame and the positioning member respectively.

In some embodiments, the positioning member includes a stop boss. The guide frame is formed with a stop slot. The stop boss is restricted in the stop slot and can slide in the stop slot. The elastic member is disposed in the stop slot and abuts against the inner wall of the stop slot and/or the stop boss.

In some embodiments, the locking device also includes an adapter block and a sliding rod. An end of the sliding rod is disposed in the adapter block. The sliding rod can slide in the adapter block and can rotate relative to the adapter block. The locking block sleeves outside the sliding rod. The handle is rotatably connected to the sliding rod.

In some embodiments, the locking device also includes a cylindrical pin rotatably connected to the handle and screwed to the sliding rod.

In some embodiments, the locking block is provided with two sliding protrusions. The two sliding protrusions are disposed opposite to each other. The handle includes two wing plates symmetrically disposed. The wing plates abut against the sliding protrusions and can slide on the sliding protrusions.

A carriage cover includes a carriage cover body, a first mounting strip, a second mounting strip, and the locking device. The first mounting strip and the second mounting strip are perpendicular to each other and are disposed on the lower side of the carriage cover body. The locking device is disposed on the second mounting strip. When the carriage cover covers the carriage, the locking device is configured to be engaged with the carriage.

### BRIEF DESCRIPTION OF DRAWINGS

FIG. 1 is a view illustrating the structure of a carriage cover according to an embodiment of the present disclosure.

FIG. 2 is an enlarged view of part A of FIG. 1.

FIG. 3 is a view illustrating the partial structure of a locking device according to an embodiment of the present disclosure.

FIG. 4 is a first axonometric view illustrating the partial structure of the locking device according to an embodiment of the present disclosure.

FIG. 5 is a second axonometric view illustrating the partial structure of the locking device according to an embodiment of the present disclosure.

FIG. 6 is a view illustrating the structure of a locking block in the locking device according to an embodiment of the present disclosure.

FIG. 7 is an axonometric view of the locking block in the locking device according to an embodiment of the present disclosure.

FIG. 8 is a view illustrating the structure of a handle in the locking device according to an embodiment of the present disclosure.

FIG. 9 is an axonometric view of the handle in the locking device according to an embodiment of the present disclosure.

FIG. 10 is a view illustrating the structure of a positioning member in the locking device according to an embodiment of the present disclosure.

FIG. 11 is a view illustrating the structure of a guide frame in the locking device according to an embodiment of the present disclosure.

FIG. 12 is an axonometric view of the guide frame in the locking device according to an embodiment of the present disclosure.

FIG. 13 is a view illustrating the structure of a locking component in the locking device according to an embodiment of the present disclosure.

### REFERENCE LIST

100 carriage
200 first mounting strip
300 second mounting strip
10 adapter block
20 sliding rod
30 locking block
40 handle
50 locking component
60 cylindrical pin
301 first hole
31 pressing plate
311 stop groove
32 support pillar
33 rib plate
34 arc plate
341 positioning recess
342 sliding protrusion
401 third hole
402 fourth hole
41 handle body
411 stop block
42 wing plate
51 positioning member
511 long strip plate
512 operation boss
513 stop boss
514 stop plate
52 guide frame
501 fastening hole
521 sliding channel
522 bypass groove
523 stop slot
53 fastener
54 elastic member
601 second hole

### DETAILED DESCRIPTION

Embodiments in accordance with the present disclosure are described in detail below. Examples of the embodiments are illustrated in the drawings, where the same or similar reference numerals indicate the same or similar elements or components having the same or similar functions. The embodiments described below with reference to the drawings are exemplary, intended to explain the present disclosure, and not to be construed as limiting the present disclosure.

In the description of the present disclosure, unless otherwise expressly specified and limited, the term “connected to each other”, “connected”, or “fixed” is to be construed in a broad sense, for example, as fixedly connected, detachably connected, mechanically connected or electrically connected, directly connected to each other or indirectly connected to each other via an intermediary, or internally connected or interactional between two components. For those of ordinary skill in the art, specific meanings of the above terms in the present disclosure can be understood according to specific conditions.

In the description of the present disclosure, unless otherwise expressly specified and limited, when a first feature is described as “on” or “below” a second feature, the first feature and the second feature may be in direct contact, or be in contact via another feature between the two features instead of being in direct contact. Moreover, when the first feature is described as “on”, “above” or “over” the second feature, the first feature is right on, above or over the second feature or the first feature is obliquely on, above or over the second feature, or the first feature is simply at a higher level than the second feature. When the first feature is described as “under”, “below”, or “underneath” the second feature, the first feature is right under, below, or underneath the second feature or the first feature is obliquely under, below, or underneath the second feature, or the first feature is simply at a lower level than the second feature.

A carriage cover for covering a carriage is hinged to a pickup truck to protect goods from the sun and rain. The carriage cover is often provided with a locking mechanism, so that the carriage cover is stably connected on the carriage. However, when a vehicle runs on a poor road section and bumps, the locking handle of the locking mechanism is easy to be detached from the carriage, resulting in that the carriage cover loses acting force. As a result, the carriage is opened, and a safety accident is easily caused. Therefore, how to ensure that the locking mechanism is not detached during the running process of the vehicle is an urgent problem to be solved at present.

The technical solutions in the embodiments are further described below through specific implementations in conjunction with the drawings.

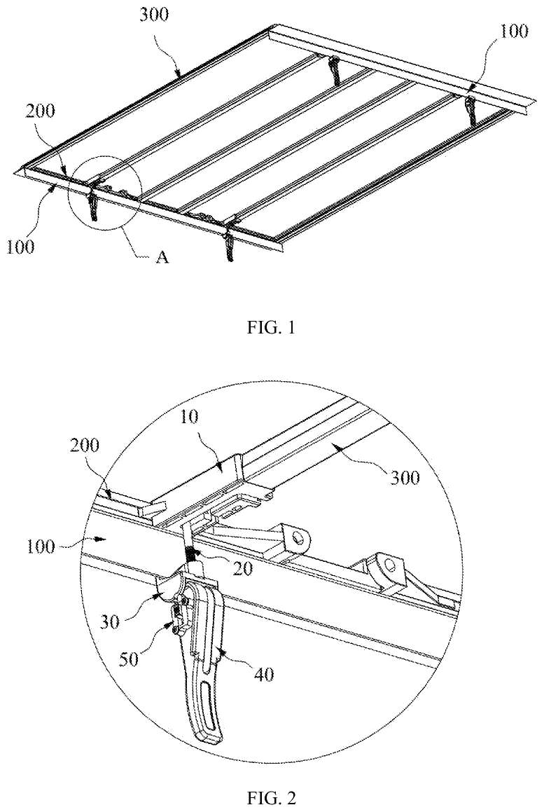

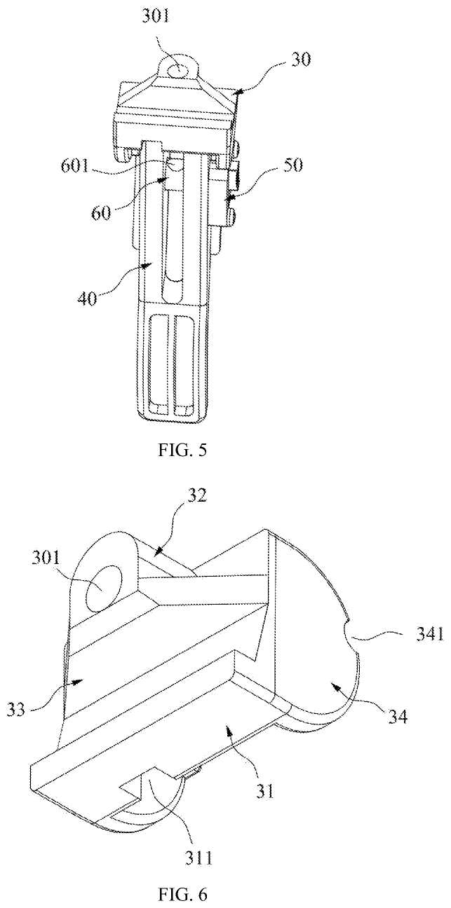

As shown in FIGS. 1 to 13, an embodiment provides a locking device and a carriage cover. The locking device is configured to be engaged with a carriage 100. The locking device includes a locking block 30, a handle 40, and a locking component 50. The locking block 30 can abut against the carriage 100. The handle 40 is slidably disposed in the locking block 30. The locking component 50 is disposed on the handle 40 and can be engaged in a positioning recess 341 of the locking block 30. When the locking component 50 is engaged in the positioning recess 341, the locking component 50 restricts relative movement between the locking block 30 and the handle 40. The carriage cover includes a carriage cover body, a first mounting strip 200, a second mounting strip 300, and the locking device. The first mounting strip 200 and the second mounting strip 300 are perpendicular to each other and are disposed on the lower side of the carriage cover body. The locking device is disposed on the second mounting strip 300. When the carriage cover covers the carriage 100, the locking device is configured to be engaged with the carriage 100 to lock the position of the carriage cover on the carriage 100.

In this embodiment, the locking block 30 abuts against the carriage 100 and can press the whole locking device on the carriage 100, thereby ensuring the stable covering of the carriage cover. The handle 40 is slidably disposed in the locking block 30. The locking component 50 is disposed on the handle 40 and can be engaged in the positioning recess 341 on the locking block 30. By rotating the handle 40, the handle 40 slides in the locking block 30 to drive the locking component 50 to move synchronously. In this manner, the state where the locking component 50 engages with the positioning recess 341 is changed, so that the state where the locking block 30 abuts against the carriage is changed.

When a vehicle runs, the locking component 50 is engaged in the positioning recess 341 to lock the positions of the locking block 30 and the handle 40 without any other external force. In this manner, relative movement between the locking block 30 and the handle 40 is avoided, so that the carriage cover is stably connected on the carriage 100, and the locking component 50 is arranged to ensure that the locking device is not easy to be detached from the carriage 100. In this embodiment, the carriage cover provided with the locking device is also provided with a first mounting strip 200 and a second mounting strip 300. Multiple locking devices can be disposed on the carriage cover body, so that the locking devices are stably mounted on the carriage cover body. Thus, during the driving process of the vehicle, the carriage cover is prevented from being detached from the carriage 100, thereby reducing the occurrence of safety accidents.

The detailed structures of the locking device and the carriage cover in this embodiment are described below.

As shown in FIGS. 1 and 2, an L-shaped plate is disposed on the sidewall of the carriage 100. The first mounting strip 200 is disposed on the lower side of the carriage cover body in the length direction of the L-shaped plate. Multiple second mounting strips 300 are disposed on the lower side of the carriage cover body and perpendicular to the first mounting strip 200. Optionally, the carriage cover body is provided with two first mounting strips 200. The two first mounting strips 200 are interposed between the L-shaped plate of the carriage 100 and the carriage cover body. Multiple second mounting strips 300 are disposed in parallel and interposed between the two first mounting strips 200. Further, multiple locking devices are disposed at intervals on a second mounting strip 300. When the carriage cover covers the carriage 100, the locking devices are configured to be engaged with the lower side of the L-shaped plate of the carriage 100, so that a first mounting strip 200 fits tightly against the upper side of the L-shaped plate. Thus, the position of the carriage cover body on the carriage 100 is locked, and the carriage cover tightly covers the carriage 100. At the same time, the first mounting strip 200 is arranged to prevent the carriage cover body from being damaged during the pressing process. In this embodiment, the first mounting strip 200 and the second mounting strip 300 are made of aluminum profiles. Not only the mounting cost is lower, but also the weight is lighter, thereby implementing the overall weight reduction of the carriage cover.

Optionally, as shown in FIGS. 2 to 5, the locking device includes an adapter block 10, a sliding rod 20, a locking block 30, a handle 40, a locking component 50, and a cylindrical pin 60. In this embodiment, one end of the adapter block 10 is disposed on the first mounting strip 200, and the other end of the adapter block 10 is inserted in by the second mounting strip 300. A slide rail is disposed on the adapter block 10. An end of the sliding rod 20 is disposed in the slide rail. The sliding rod 20 can slide in the extension direction of the slide rail in the adapter block 10 and can rotate relative to the adapter block 10. In this manner, the locking device is connected to the carriage cover body. Further, the adapter block 10 is formed with accommodation space. Thus, the locking device, except for the part of the adapter block 10, is stored in the accommodation space and rotates about an end of the sliding rod 20 in the accommodation space. In this manner, when the locking device is not used, the locking device can be stored properly to improve the space utilization rate.

Optionally, the sliding rod 20 includes a sliding block and a screw rod. The sliding block is fixedly connected to one end of the screw rod. The locking block 30 sleeves outside the other end of the screw rod. The handle is rotatably connected to the screw rod. The sliding block is embedded in the slide rail of the adapter block 10. The side of the slide rail facing the carriage 100 is formed with a moving channel. The length of the moving channel may be set as required. The width of the moving channel is slightly larger than the diameter of the screw rod, so that the sliding block cannot fall off from the slide rail. The screw rod can move in the sliding moving channel without obstacles, so that the position of the sliding block in the slide rail changes so as to change the distance between the whole locking device and the sidewall of the carriage 100 and control the cover state of the carriage cover to change.

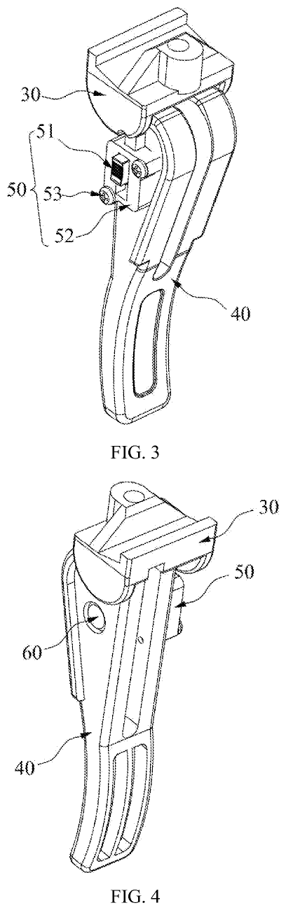

Optionally, as shown in FIGS. 3 to 5, the locking block 30 is configured to abut against and be engaged with the L-shaped plate of the sidewall of the carriage 100. The handle 40 is slidably disposed in the locking block 30. The locking component 50 is disposed on a side of the handle 40. The cylindrical pin 60 is rotatably disposed in the handle 40. In this embodiment, the locking block 30 is formed with a first hole 301. The cylindrical pin 60 is formed with a second hole 601. The first hole 301 is configured as an unthreaded hole. The second hole 601 is configured as a threaded hole. The screw rod is sequentially threaded through the first hole 301 and the second hole 601 and screwed to the cylindrical pin 60 through the second hole 601. Thus, the sliding rod 20 is stably connected to the locking block 30 and the handle 40, and the handle 40 can rotate about the cylindrical pin 60 relative to the screw rod and the locking block 30. Further, after the locking block 30 abuts against the carriage 100 and locks the position of the carriage cover on the carriage 100, the handle 40 is rotated to change the locking state of the locking block 30.

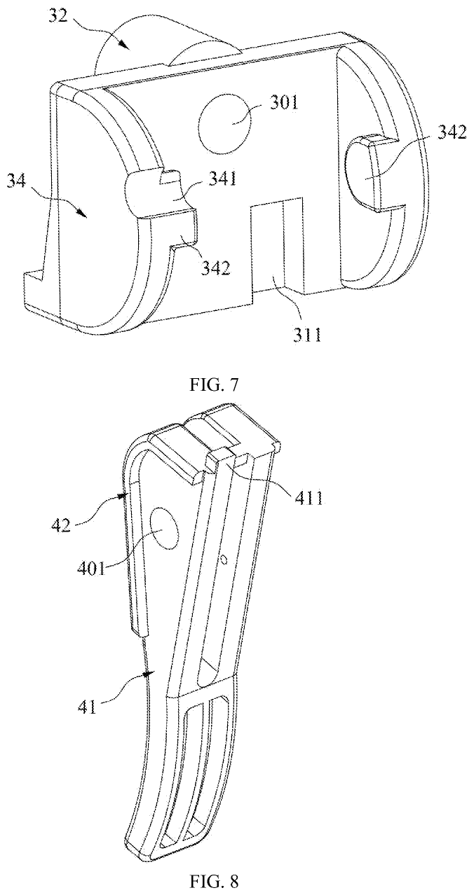

Specifically, as shown in FIGS. 6 to 7, the locking block 30 includes a pressing plate 31, a support pillar 32, a rib plate 33, and an arc plate 34. The locking block 30 is formed with the first hole 301. A pressing plate 31 is formed with a stop groove 311. The arc plate 34 is formed with a positioning recess 341 and provided with a sliding protrusion 342.

Optionally, an end of the pressing plate 31 extends in the axial direction of the screw rod and forms a pressing platform. The pressing platform is configured to press against the L-shaped plate of the sidewall of the carriage 100. The lower side of the pressing plate 31 is formed with the stop groove 311. The stop groove 311 is configured to restrict the handle 40. Further, the upper side of the pressing plate 31 is fixedly connected to the support pillar 32 and the rib plate 33. In this embodiment, the support pillar 32 is a cylindrical structure. The axial direction of the support pillar 32 is parallel to the axial direction of the screw rod. The support pillar 32 is formed with a first hole 301 in the axial direction of the screw rod. The first hole 301 penetrates the support pillar 32 and the pressing plate 31 to facilitate the extension and connection of the sliding rod 20. Further, the rib plate 33 is parallel to the axial direction of the support pillar 32 and fixedly connected to the side surface of the support pillar 32 to provide support for the support pillar 32, thereby improving the connection strength of the support pillar 32. Thus, the sliding rod 20 is prevented from applying force on the inner wall of the support pillar 32 to break the support pillar 32.

Optionally, the locking block 30 is provided with two arc plates 34. The two arc plates 34 are symmetrically disposed on two sides of the pressing plate 31 and fixedly connected to the pressing plate 31. Optionally, the two arc plates 34 are disposed on two sides of the pressing platform. One of the arc plates 34 is formed with a positioning recess 341 configured to restrict the position of the locking component 50. Optionally, the positioning recess 341 is configured as an arc recess. Further, as shown in FIG. 7, the two arc plates 34 are provided with sliding protrusions 342, and the two sliding protrusions 342 are disposed opposite to each other. Optionally, the lower side of the pressing plate 31, the inner sides of the two arc plates 34, and the two sliding protrusions 342 are enclosed to form a sliding space. The handle 40 can slide against the sliding protrusions 342 in the sliding space. In this manner, the handle 40 is slidably connected to the locking block 30.

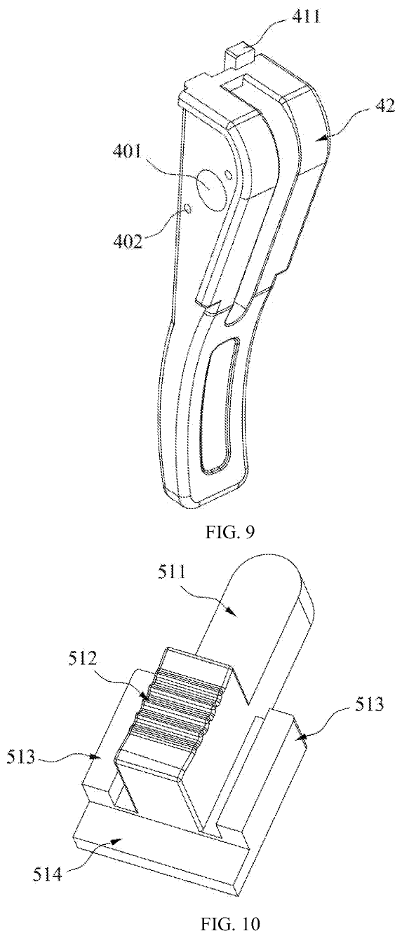

Specifically, as shown in FIGS. 8 to 9, the handle 40 includes a handle body 41 and a wing plate 42. The handle body 41 is formed with a third hole 401 and a fourth hole 402, and a stop block 411 is also disposed on the handle body 41.

Optionally, the handle body 41 is provided with a rotation portion and a hand-held portion. The outside of the rotation portion is fixedly connected to two wing plates 42 symmetrically disposed. The wing plates 42 are adhered to the outside of the rotation portion and extend to the hand-held portion. The two wing plates 42 extend outward in the thickness direction of the rotation portion and form sliding grooves on two sides of the rotation portion. Specifically, the top end of the handle body 41 extends into the sliding space. The sliding protrusion 342 is restricted in the sliding groove and abuts against the lower side of a wing plate 42. In this manner, the wing plate 42 can slide on the sliding protrusion 342, so that the rotation portion of the handle body 41 is rotatably connected to the locking block 30 under the cooperation of the wing plate 42 and the sliding protrusion 342.

Optionally, an elongated through groove is formed through the rotation portion. A rotation space is formed between the two wing plates 42. The elongated through groove communicates with the rotation space. The cylindrical pin 60 is disposed in the rotation space. The sliding rod 20 is screwed to the cylindrical pin 60 and disposed in the rotation space. Optionally, a third hole 401 is formed through the rotation portion in the thickness direction of the rotation portion. Two ends of the cylindrical pin 60 are rotatably disposed in the third hole 401, so that the cylindrical pin 60 is rotatably connected to the handle 40. Thus, the relative position of the cylindrical pin 60 and the sliding rod 20 is constant. When the rotation portion of the handle body 41 slides on the sliding protrusion 342 and rotates about the cylindrical pin 60, the sliding rod 20 is disposed through the rotation space and the elongated through groove to avoid interference with the movement of the handle 40.

Further, the stop block 411 is disposed at the top end of the rotation portion above one of the wing plates 42. The stop block 411 and the stop groove 311 can be engaged with each other. Thus, when the wing plates 42 of two sides of the rotation portion are erected on the sliding protrusion 342, under the engagement and restriction of the stop block 411 and the stop groove 311, the top end of the handle body 41 is not easy to fall off after swinging left and right in the sliding space, so that the handle 40 is not easy to fall off the sliding space during rotating. On the side of the rotation portion far away from the stop block 411, a fourth hole 402 is formed through the rotation portion in the thickness direction of the rotation portion and communicates with the rotation space. Alternatively, the fourth hole 402 is configured as a blind hole for stably mounting the locking component 50. Optionally, the hand-held portion is correspondingly formed with grooves of different sizes to implement a weight reduction effect.

As shown in FIGS. 10 to 13, the locking component 50 includes a positioning member 51, a guide frame 52, a fastener 53, and an elastic member 54. The positioning member 51 includes a long strip plate 511, an operation boss 512, a stop boss 513, and a stop plate 514. The guide frame 52 is formed with a fastening hole 501, a slide channel 521, a bypass groove 522, and a stop slot 523.

As shown in FIG. 10, the upper end of the long strip plate 511 of the positioning member 51 is configured as an arc protruding block, which is adapted to the shape of the arc recess of the positioning recess 341. Thus, the long strip plate 511 and the positioning recess 341 can be engaged with each other, so that the positioning member 51 and the locking block 30 can be restricted and fixed. In this manner, the safety accident in which the locking block 30 is detached from the sidewall of the carriage 100 due to the rotation between the handle 40 and the locking block 30 when the vehicle bumps excessively during running in poor road conditions is avoided. Further, the long strip plate 511 is fixedly connected to the operation boss 512. The upper surface of the operation boss 512 is provided with an uneven contact portion to improve frictional force. In this manner, an operator can move the long strip plate 511 by pushing the contact portion.

Further, two sides of the long strip plate 511 are provided with stop bosses 513 respectively. The stop bosses 513 are embedded in the guide frame 52. In the protrusion direction of the operation platform 512 on the long strip plate 511, the height of a stop boss 513 is smaller than the thickness of the long strip plate 511. Further, in the length direction of the long strip plate 511, two stop bosses 513 and the lower side of the operation platform 512 are fixedly connected to the stop plate 514.

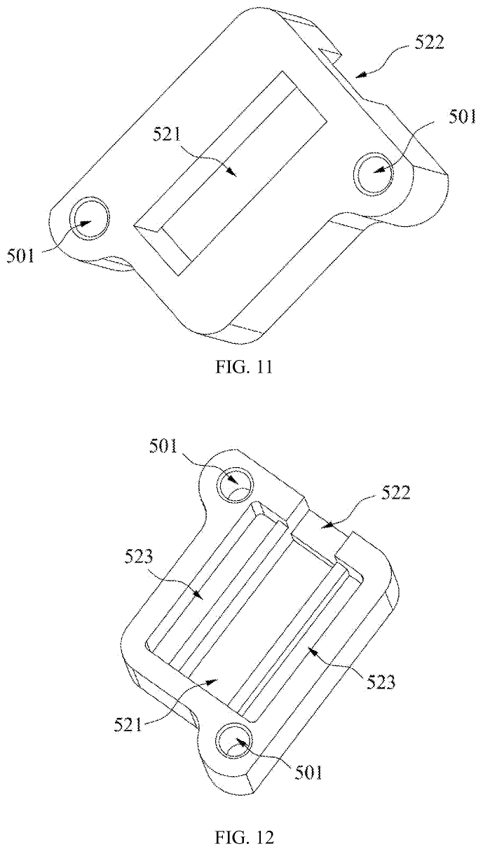

As shown in FIG. 11, the fastening hole 501 is formed through the guide frame 52. The position of the fastening hole 501 is adapted to the position of the fourth hole 402 on the rotation portion of the handle body 41. The fastener 53 sequentially extends through the fastening hole 501 and the fourth hole 402, so that the guide frame 52 can be fixed on the handle body 41. Thus, the locking component 50 is firmly connected to the handle 40. For example, in this embodiment, two fourth holes 402 are disposed in the rotation portion and are symmetrically distributed in the circumferential direction of the third hole 401. Accordingly, two fastening holes 501 are also disposed. The fastener 53 is configured as a screw. Thus, two screws mounted symmetrically make the locking component 50 mounted stably and not easy to fall off the handle 40. In other embodiments, the number and positions of fourth holes 402 and fastening holes 501 may be set as required.

Further, the sliding channel 521 is formed through the guide frame 52 in the axis direction of the fastening hole 501. The extension direction of the sliding channel 521 is configured as the first direction. Two ends of the sliding channel 521 are closed ends. The operation boss 512 is restricted in the sliding channel 521. The lower side of the guide frame 52 is also formed with the bypass groove 522 in the first direction. As shown in FIG. 12, the arc protruding block of the long strip plate 511 is located in the bypass groove 522. The portion of the long strip plate 511 connected to the operation boss 512 is located in the sliding channel 521. In the first direction, the length of the sliding channel 521 is larger than the length of the operation boss 512. Thus, the long strip plate 511 and the operation boss 512 can slide in the sliding channel 521. Optionally, in the width direction of the sliding channel 521, the width of the sliding channel 521 is slightly larger than the width of the operation boss 512, and/or the size of the bypass groove 522 is slightly larger than the size of the arc protruding block. Thus, the operation boss 512 can move in a straight line in the sliding channel, thereby ensuring that the long strip plate 511 can be stably engaged with the positioning recess 341.

Specifically, when the operation boss 512 moves in the sliding channel 521 in the first direction toward the side of the bypass groove 522, the long strip plate 511 synchronously moves in the sliding channel 521 and the bypass groove 522 in the first direction until the long strip plate 511 is engaged in the positioning recess 341, so that locking is completed. When the operation boss 512 moves in the sliding channel 521 in the first direction away from the side of the bypass groove 522, the long strip plate 511 synchronously moves in the sliding channel 521 and the bypass groove 522 in the first direction until the long strip plate 511 leaves the positioning recess 341, so that the unlocking is implemented.

As shown in FIG. 12, two sides of the bypass groove 522 are formed with stop slots 523 respectively. The stop boss 513 can be engaged in a stop slot 523. In the first direction, the length of the stop slot 523 is larger than the length of the stop boss 513. Thus, the stop boss 513 slides in the stop slot 523 synchronously during movement of the operation boss 512 and the long strip plate 511 in the first direction. Further, the elastic member 54 is also disposed in the stop slot 523. Two ends of the elastic member 54 abut against the inner wall of the stop slot 523 and/or the stop boss 513 respectively, so that the positioning member 51 is flexibly engaged with the positioning recess 341, and the positioning member 51 can change the engagement state to adapt to different use situations. Optionally, the stop plate 514 covers part of the elastic member 54 to prevent elastic member 54 from being excessively compressed by the positioning member 51 to lose the elastic effect. Similarly, the operation boss 512 is disposed so that when the elastic member 54 is in a stuck state during use, the operation boss 512 can be driven, and thus the long strip plate 511 is separated from or engaged in the positioning recess 341. For example, the elastic member 54 is configured as a spring.

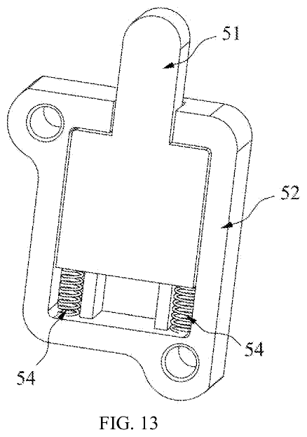

Further, as shown in FIG. 13, in this embodiment, the positioning member 51 is integrally embedded in the guide frame 52, that is, the bottom surface of the guide frame 52 is located on the same horizontal plane as the bottom surface of the positioning member 51. Thus, when the guide frame 52 presses the positioning member 51 against the handle 40 and mounts the positioning member 51 on the handle 40, the bottom surface has no gap. In this manner, the internal positioning member 51 and elastic member 54 are better protected, and the service life is prolonged. For example, under no external force, the elastic member 54 is always in a compressed state in the guide frame 52, that is, the long strip plate 511 is always in an extended state in the bypass groove 522.

In this embodiment, the working process of the locking device is below.

When the carriage cover covers the carriage 100, the sliding rod 20 and the locking device are rotated about the top end of the sliding rod 20. The locking device is adjusted to the vicinity of the sidewall of the carriage 100. The position of the locking device on the sliding rod 20 is adjusted, so that the locking block 30 abuts against the lower side of the L-shaped plate of the sidewall of the carriage 100. The first mounting strip 200 is interposed and fixed between the carriage cover and the carriage 100. By rotating handle 40, the positioning member 51 compresses the elastic member 54 under the pressing action of the arc plate 34 of the locking block 30 until the arc protruding block of the long strip plate 511 is engaged in the positioning recess 341. The locking of the locking device is completed. In this manner, the carriage cover cannot be separated from the carriage 100.

When the carriage cover is opened on the carriage 100, the handle 40 is rotated to make the positioning member 51 compress the elastic member 54 under compression of the arc plate 34 of the locking block 30 until the arc protruding block of the long strip plate 511 is separated from the positioning recess 341. Thus, the release of the locking device is completed. In this manner, the carriage cover can be opened from the carriage 100. Then, the sliding rod 20 and the locking device are rotated about the top end of the sliding rod 20, so that the locking device moves away from the carriage 100. The position of the locking device on the sliding rod 20 is adjusted, so that the locking device can be stored in the adapter block 10.

What is claimed is:

1. A locking device, configured to be engaged with a carriage, comprising:
a locking block capable of abutting against the carriage;
a handle slidably disposed in the locking block; and
a locking component disposed on the handle and capable of being engaged in a positioning recess of the locking block, wherein when the locking component is engaged in the positioning recess, the locking component restricts relative movement between the locking block and the handle.

2. The locking device according to claim 1, wherein the locking component comprises a positioning member and a guide frame, the guide frame is disposed on the handle, and the positioning member is slidably disposed in the guide frame and capable of being engaged in the positioning recess.

3. The locking device according to claim 2, wherein the positioning member comprises a long strip plate, the long strip plate is capable of being engaged in the positioning recess, the guide frame is formed with a bypass groove, and the long strip plate is located in the bypass groove and capable of sliding in the bypass groove.

4. The locking device according to claim 3, wherein the positioning member further comprises an operation boss disposed on the long strip plate, the guide frame is further formed with a sliding channel extending in a first direction, the operation boss is restricted in the sliding channel, and when the operation boss moves in the sliding channel in the first direction, the long strip plate synchronously moves in the bypass groove in the first direction.

5. The locking device according to claim 2, wherein the locking component further comprises an elastic member disposed in the guide frame, and two ends of the elastic member abut against the guide frame and the positioning member respectively.

6. The locking device according to claim 5, wherein the positioning member comprises a stop boss, the guide frame is formed with a stop slot, the stop boss is restricted in the stop slot and is capable of sliding in the stop slot, and the elastic member is disposed in the stop slot and abuts against an inner wall of the stop slot and/or the stop boss.

7. The locking device according to claim 1, further comprising an adapter block and a sliding rod, wherein an end of the sliding rod is disposed in the adapter block, the sliding rod is capable of sliding in the adapter block and is capable of rotating relative to the adapter block, the locking block sleeves outside the sliding rod, and the handle is rotatably connected to the sliding rod.

8. The locking device according to claim 7, further comprising a cylindrical pin rotatably connected to the handle and screwed to the sliding rod.

9. The locking device according to claim 1, wherein the locking block is provided with two sliding protrusions, the two sliding protrusions are disposed opposite to each other, the handle comprises two wing plates symmetrically disposed, and the two wing plates abut against the two sliding protrusions and are capable of sliding on the two sliding protrusions.

10. A carriage cover, comprising a carriage cover body, a first mounting strip, a second mounting strip, and the locking device according to claim 1, wherein the first mounting strip and the second mounting strip are perpendicular to each other and are disposed on a lower side of the carriage cover body, the locking device is disposed on the second mounting strip, and when the carriage cover covers the carriage, the locking device is configured to be engaged with the carriage.

11. The carriage cover according to claim 10, wherein the locking component comprises a positioning member and a guide frame, the guide frame is disposed on the handle, and the positioning member is slidably disposed in the guide frame and capable of being engaged in the positioning recess.

12. The carriage cover according to claim 11, wherein the positioning member comprises a long strip plate, the long strip plate is capable of being engaged in the positioning recess, the guide frame is formed with a bypass groove, and the long strip plate is located in the bypass groove and capable of sliding in the bypass groove.

13. The carriage cover according to claim 12, wherein the positioning member further comprises an operation boss disposed on the long strip plate, the guide frame is further formed with a sliding channel extending in a first direction, the operation boss is restricted in the sliding channel, and when the operation boss moves in the sliding channel in the first direction, the long strip plate synchronously moves in the bypass groove in the first direction.

14. The carriage cover according to claim 11, wherein the locking component further comprises an elastic member disposed in the guide frame, and two ends of the elastic member abut against the guide frame and the positioning member respectively.

15. The carriage cover according to claim 14, wherein the positioning member comprises a stop boss, the guide frame is formed with a stop slot, the stop boss is restricted in the stop slot and is capable of sliding in the stop slot, and the elastic member is disposed in the stop slot and abuts against an inner wall of the stop slot and/or the stop boss.

16. The carriage cover according to claim 10, wherein the locking device further comprises an adapter block and a sliding rod, wherein an end of the sliding rod is disposed in the adapter block, the sliding rod is capable of sliding in the adapter block and is capable of rotating relative to the adapter block, the locking block sleeves outside the sliding rod, and the handle is rotatably connected to the sliding rod.

17. The carriage cover according to claim 16, wherein the locking device further comprises a cylindrical pin rotatably connected to the handle and screwed to the sliding rod.

18. The carriage cover according to claim 10, wherein the locking block is provided with two sliding protrusions, the two sliding protrusions are disposed opposite to each other, the handle comprises two wing plates symmetrically disposed, and the two wing plates abut against the two sliding protrusions and are capable of sliding on the two sliding protrusions.
